(19) United States
(12) Patent Application Publication
(10) Pub. No.: US 2024/0078623 A1
(43) Pub. Date: Mar. 7, 2024

(54) IDENTIFYING AND QUANTIFYING LEGAL TERMS AND CONDITIONS

(71) Applicant: International Business Machines Corporation, Armonk, NY (US)

(72) Inventors: Rajesh Kumar Saxena, Thane East (IN); Harish Bharti, Pune (IN); Pinaki Bhattacharya, Pune (IN); Sandeep Sukhija, Rajasthan (IN)

(21) Appl. No.: 17/890,586

(22) Filed: Aug. 18, 2022

(51) Int. Cl. G06Q 50/18

(52) U.S. Cl. CPC G06Q 50/188

(57) ABSTRACT

An approach for assessing terms and conditions (TnC)s of a legal agreement is provided. A block of text, which contains a TnC of the set of TnC, in the legal agreement is identified using a cognitive system. A standardized significance value is assigned to the TnC by the cognitive system by applying the TnC to a TnC model containing corresponding industry TnCs from industry standard documents. A block currency that indicates a significance of an impact of the TnC to a contract party is computed for the TnC by the cognitive system. Based on the standardized significance value and the block currency, a personal impact of the TnC to the contract party is assessed by the cognitive system. The contract party is alerted to the TnC and the personal impact corresponding to the TnC.

The present invention relates to artificial augmentation of human intelligence. Specifically, the present invention relates to automatically identifying a set of legal terms and conditions located within a legal document and assessing the individual impact of the terms and conditions to a contract party.

### BACKGROUND

In today's modern environment, legal agreements are ubiquitous. These legal agreements can take the form of loan agreements, insurance binders, lease agreements, credit card terms and conditions statements, software licensing (so called “shrink wrap”) agreements, service agreements (including those for online services), and other documents having terms and conditions for contracts, leases, and/or the like. These legal agreements often contain important provisions that the parties should be aware of including, but not limited to, financial requirements, payment information, interest rate information, grace periods, results of late payment, other actions that could lead to penalties, incentives, rewards, provisions for disclosure of personal information, and/or the like.

In spite of the importance of the information contained therein, those who utilize the services associated with a legal agreement often do not read and fully comprehend the terms and conditions “TnC” (e.g., contractual rights, terms of service, etc.) contained in the “fine print”. Various reasons for this behavior can include the complex and long-winded language, length of TnC docs, and time, energy and attention span required to read them, among others. A study performed by the British publication The Guardian® found that only 7% of Britons read the online terms and conditions when signing up for products and services. Similarly, A Deloitte survey of 2,000 consumers in the U.S. found that 91% of people consent to legal terms and services conditions without reading them. This happens despite the fact the overwhelming majority of individuals understand that they ought to read and understand the “fine print”.

### SUMMARY

Embodiments of the present invention provide an approach for assessing terms and conditions (TnC)s of a legal agreement. A block of text, which contains a TnC of the set of TnC, in the legal agreement is identified using a cognitive system. A standardized significance value is assigned to the TnC by the cognitive system by applying the TnC to a TnC model containing corresponding industry TnCs from industry standard documents. A block currency that indicates a significance of an impact of the TnC to a contract party is computed for the TnC by the cognitive system. Based on the standardized significance value and the block currency, a personal impact of the TnC to the contract party is assessed by the cognitive system. The contract party is alerted to the TnC and the personal impact corresponding to the TnC.

One aspect of the present invention includes a computer-implemented method for assessing terms and conditions (TnC)s of a legal agreement, comprising the computer-implemented steps of: identifying, using a cognitive system, a block of text in the legal agreement, the block containing a TnC of a set of the TnCs in the legal agreement; assigning, by the cognitive system, a standardized significance value to the TnC by applying the TnC to a TnC model containing corresponding industry TnCs from industry standard documents; computing, by the cognitive system, a block currency for the TnC that indicates a significance of an impact of the TnC to a contract party; assessing, by the cognitive system, a personal impact of the TnC to the contract party based on the standardized significance value and the block currency; and alerting the contract party to the TnC and the personal impact corresponding to the TnC.

A second aspect of the present invention provides a system for assessing terms and conditions (TnC)s of a legal agreement, comprising: a memory medium comprising program instructions; a bus coupled to the memory medium; and a processor, for executing the program instructions, coupled to the memory medium that when executing the program instructions causes the system to: identify, using a cognitive system, a block of text in the legal agreement, the block containing a TnC of a set of the TnCs in the legal agreement; assign, by the cognitive system, a standardized significance value to the TnC by applying the TnC to a TnC model containing corresponding industry TnCs from industry standard documents; compute, by the cognitive system, a block currency for the TnC that indicates a significance of an impact of the TnC to a contract party; assess, by the cognitive system, a personal impact of the TnC to the contract party based on the standardized significance value and the block currency; and alert the contract party to the TnC and the personal impact corresponding to the TnC.

A third aspect of the present invention provides a computer program product for assessing terms and conditions (TnC)s of a legal agreement, the computer program product comprising a computer readable storage device, and program instructions stored on the computer readable storage device, to: identify, using a cognitive system, a block of text in the legal agreement, the block containing a TnC of a set of the TnCs in the legal agreement; assign, by the cognitive system, a standardized significance value to the TnC by applying the TnC to a TnC model containing corresponding industry TnCs from industry standard documents; compute, by the cognitive system, a block currency for the TnC that indicates a significance of an impact of the TnC to a contract party; assess, by the cognitive system, a personal impact of the TnC to the contract party based on the standardized significance value and the block currency; and alert the contract party to the TnC and the personal impact corresponding to the TnC.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing environment in which the invention may be implemented according to an embodiment of the present invention;

FIG. 2 shows a system diagram describing the functionality discussed herein according to an embodiment of the present invention;

FIG. 3 shows a block diagram that illustrates a system according to illustrative embodiments;

FIG. 4 shows a logical flow diagram according to illustrative embodiments;

FIG. 5 shows a logical flow diagram according to illustrative embodiments; and

FIG. 6 depicts a method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the embodiments set forth herein. Rather, these illustrative embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof. Furthermore, the term “developer” refers to any person who writes computer software. The term can refer to a specialist in one area of computer programming or to a generalist who writes code for many kinds of software.

As indicated above, embodiments of the present invention provide an approach for assessing terms and conditions (TnC)s of a legal agreement. A block of text, which contains a TnC of the set of TnC, in the legal agreement is identified using a cognitive system. A standardized significance value is assigned to the TnC by the cognitive system by applying the TnC to a TnC model containing corresponding industry TnCs from industry standard documents. A block currency that indicates a significance of an impact of the TnC to a contract party is computed for the TnC by the cognitive system. Based on the standardized significance value and the block currency, a personal impact of the TnC to the contract party is assessed by the cognitive system. The contract party is alerted to the TnC and the personal impact corresponding to the TnC.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

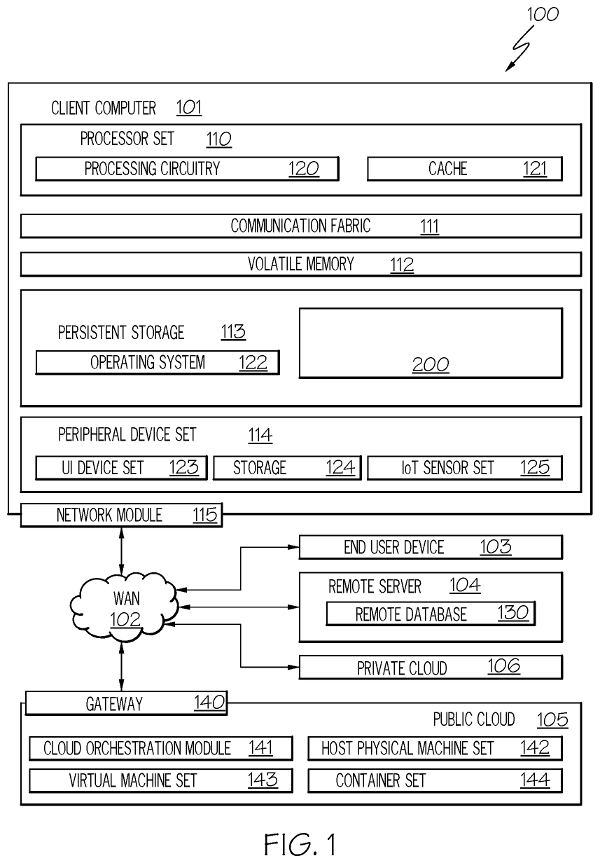

Referring now to FIG. 1, computing environment 100 contains an example of an environment for the execution of at least some of the computer code involved in performing the inventive methods, such as TnC assessing engine 200 (hereinafter “system 200”). In addition to system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

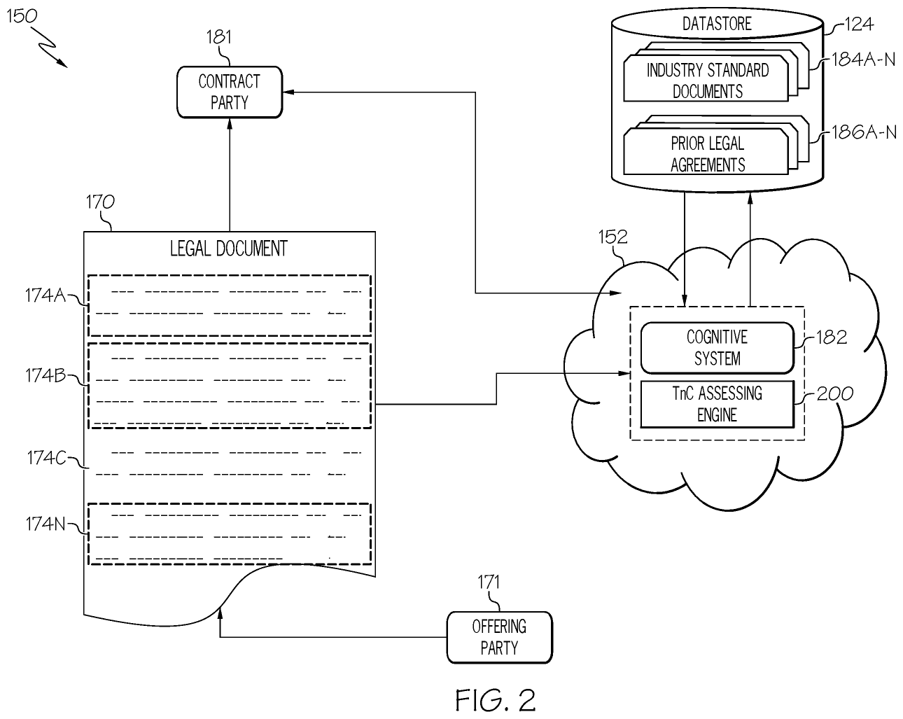

Referring now to FIG. 2, a system diagram describing the functionality discussed herein according to an embodiment of the present invention is shown. It is understood that the teachings recited herein may be practiced within any type of networked computing environment 150 (e.g., a cloud computing environment 152). A stand-alone computing environment is shown in FIG. 2 for illustrative purposes only. In the event the teachings recited herein are practiced in a networked computing environment, each client need not have a TnC assessing engine (hereinafter “system 200”). Rather, all or part of system 200 could be loaded on a server or server-capable device that communicates (e.g., wirelessly) with the clients to provide for assessing terms and conditions (TnC)s of a legal agreement.

As shown, an offering party 171 is forwarding a legal document 170 to contract party 181. Legal document 170 can be or can include provisions of a loan agreement, insurance binder, lease agreement, credit card terms and conditions statement, software licensing (so called “shrink wrap”) agreement, service agreement (including those for online services) and/or any other document that contains terms and conditions (TnC) that may be legally binding. Moreover, legal document 170 can take the form of a new offering or an updated version of a previous offering that has updated TnCs.

The inventors of the invention described herein have discovered a number of challenges in the way in which contract parties 181 review legal documents 170 which can cause deficiencies in the manner in which the TnCs included therein are assessed. For example, it can often take a significant amount of time to read through many legal documents 170. Given how many legal documents 170 a contract party 181 may receive in a particular time frame, this could eat up large amounts of time that the contract party 181 could more effectively spend doing other things. Further, because the language contained in legal documents 170 contains legal terms that may be not only difficult for a non-lawyer contract party 181 to understand, but also tedious to read, important TnCs that are contained within a legal document 170 may be overlooked or the importance thereof may be misunderstood. Still further, even if a legal document 170 is an updated version of a previous legal document 170 in which only one or a few TnCs have changed, often the entire legal document 170 is presented to the contract party 181 without the changes being highlighted, necessitating the reading of the entire legal document 170 by the contract party in order to discover the few changes. Moreover, even if the contract party 181 is able to read, retain, and understand all of the TnCs contained in the legal document 170, often the contract party 181 may have no way of knowing which TnCs in the legal document 170 deviate from industry standards and by how much and no way of being able to assess the impact that such deviations may have on them personally.

The invention described herein utilizes a cognitive system 182 to analyze a legal document 170, identify TnCs in the legal document 170, and assess the impact of the TnCs to a specific contract party 181 on an individual basis. Cognitive system 182 can identify TnCs in a legal document 170 and can also evaluate the TnCs both in terms of how far they deviate from corresponding industry TnCs and in terms of the importance to the TnC to a specific contract party 181. This evaluation can be performed over all of the TnCs in the legal document 170, highlighting significant TnCs to the contract party 181 and allowing the user to designate whether specific TnCs are acceptable or not. In addition, the invention can provide a quantifiable cost-benefit analysis of the legal document as a whole, which the contract party 181 would be unable to perform on his or her own.

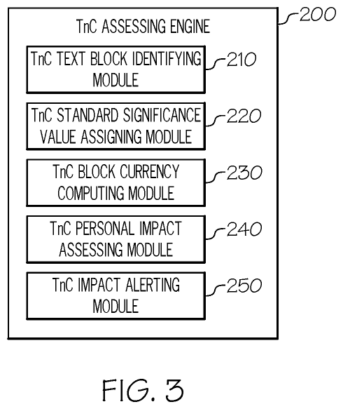

Referring now to FIG. 3, a block diagram that illustrates system 200 is depicted according to illustrative embodiments. It should be understood that system 200 can be implemented as program/utility on computing environment 100 of FIG. 1 and can enable the functions recited herein. Along these lines, system 200 may perform multiple functions. Specifically, among other functions, system 200 can assess terms and conditions (TnC)s of a legal agreement in a networked computing environment. To accomplish this, system 200 can include a set of components (e.g., program modules) for carrying out embodiments of the present invention. These components can include, but are not limited to, TnC text block identifying module 210, TnC standard significance value assigning module 220, TnC block currency computing module 230, TnC personal impact assessing module 240, and TnC impact alerting module 250.

Referring now to FIG. 2 in conjunction with FIG. 3, TnC text block identifying module 210, as executed by computing environment 100, is configured to identify, using cognitive system 182 a block of text 174N (hereinafter generic singular 174N, generic plural 174A-N) that contains a TnC. Cognitive system 182 includes a cognitive engine, such as IBM's Watson Search or Watson Explorer (IBM is a registered trademark and Watson is a trademark of International Business Machines Corporation) that utilizes machine learning to evaluate the blocks of text 174A-N contained in digital legal document 170, as well as to assess a quantitative impact of the TnCs contained in these blocks of text based on industry standard documents 184A-N, prior legal agreements 186A-N, and/or the like. To accomplish this, cognitive system 182 is trained via a set of training data to identify the blocks of text 174A-N in legal document 170 that contain TnCs. For example, cognitive system can be trained with a set of labeled data that identifies TnCs within sample legal contracts (e.g., from industry standard documents). Then, unlabeled data can be run on cognitive system 182, results checked against expected results, and parameters within cognitive system tuned until cognitive system 182 has been fully trained, giving cognitive system 182 the ability to auto ingest the terms and conditions of legal document 170, instantaneously decode the TnCs, and identify key points and/or legal rights contained therein.

Once trained, cognitive system 182 can evaluate any new legal document 170 to identify blocks of text 174A-N that may be contain TnCs. Alternatively, cognitive system 182 can detect that legal document 170 is an updated version of a previously submitted legal document 170. In such a case, cognitive system 182 can identify only the blocks of text 174A-N that contain TnCs that have changed from the previous version of legal document 170. In any case, a TnC can include, but is not limited to, language pertaining to financial requirements, payment information, interest rate information, grace periods, results of late payment, other actions that could lead to penalties, incentives, rewards, provisions for disclosure of personal information, and/or the like. As stated, legal agreement can contain a large number of blocks of text 174A-N, some of which contain one or more TnCs and others that do not. As shown, TnC text block identifying module 210 has identified, blocks of text 174A, 174B, and 174N and containing TnCs, while block of text 174C has not been identified as containing any TnC.

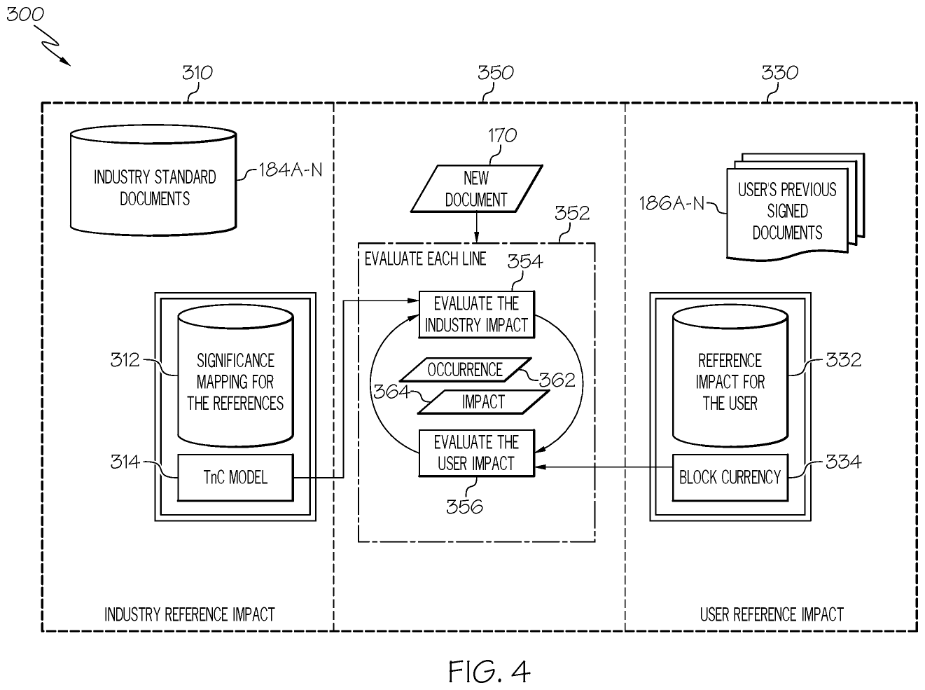

Referring now to FIG. 4, a logical flow diagram 300 is shown according to illustrative embodiments. As shown, logical flow diagram 300 is divided into three sections: an industry impact section 310, a user reference impact section 330, and a TnC assessment section 350.

Referring to FIG. 4 in conjunction with FIGS. 2 and 3, TnC standard significance value assigning module 220, as executed by computing environment 100, is configured to assign a standardized significance value to the TnC contained in text block 174N identified by block identifying module 210. To accomplish this, cognitive system 182 can apply the TnC from text block 174N to a TnC model 314 that contains corresponding industry TnCs from industry standard documents 184A-N. This TnC model 314 takes the references from industry standard documents 184A-N and uses significance mapping for the references 312 to establish the value of significance for a given reference.

In order to accomplish this, cognitive system 182 can search a number of industry standard documents 184A-N to discover industry TnCs within industry legal documents 170. This discovery of industry TnCs can be performed using techniques similar to those used by TnC text block identifying module 210 to discover blocks of text 174A-N containing TnCs in legal document 170. In any case, once the industry TnCs have been discovered, each industry TnC of the industry TnCs can be collated into one or a plurality of corresponding TnC groups that corresponds to the particular industry TnC. As a result of the collating, each of the plurality of corresponding TnC groups will contain a plurality of corresponding TnC (e.g., TnCs that relate to a common category of legal term or condition). For example, a first corresponding TnC group could contain industry TnCs that relate to credit card interest rates, while and a second corresponding TnC group could contain industry TnCs that relate rental agreement grace periods and a third corresponding TnC group could contain industry TnCs that relate to minimum balance requirements for financial accounts.

In any case, once the corresponding TnC groups have been created, cognitive system 182 can determine a TnC norm that pertains to each corresponding TnC group of the corresponding TnC groups. In order to determine the TnC norm, cognitive system 182 can use any solution for performing statistical analysis including, but not limited to, Gaussian distribution, mean, median, mode, clustering, weighted averaging (including time weighted averaging), and/or the like.

Whatever the case, once the TnC norm pertaining to the particular corresponding TnC group has been determined, cognitive system 182 can perform significance mapping for the references (TnCs) 312 to assign a significance value to each industry TnC that is a member of the corresponding TnC group. To this extent, each assigned significance value indicates the amount, if any, that a particular TnC deviates from the industry standard, as indicated by the TnC norm. For example, if an industry TnC in a particular rental agreement industry standard document 184N gives a 15-day grace period for payment, and cognitive system 182 has determined that the TnC norm is also 15 days, then cognitive system 182 could assign a neutral value (e.g., “neutral”, 0, and/or the like) to the industry TnC. In another example, suppose that cognitive system 182 has determined that the TnC norm for minimum checking account balance in order not to be charged a penalty is $0. An industry TnC in the corresponding TnC group that specifies a minimum balance requirement of $50 may be assigned a relatively low significance value while another industry TnC that has a minimum balance requirement of $500 may be assigned a relatively higher significance value in the significance mapping for references 312. Moreover, the difference in values between the two significance values can be represented textually (“significant”, “highly significant”, etc.), as a function of the absolute distance from the TnC norm, as a function of the standard deviation from the norm, and/or using any other solution now known or later developed for indicating difference with respect to a normative value. In yet another example, an industry TnC obtained from a particular industry standard document 184N may differ from the TnC norm of its corresponding TnC group in a way that is beneficial (e.g., a financial account interest rate that is higher than the TnC norm, a loan interest rate that is lower than the TnC norm, and/or the like) to contract party 181. In such a situation, significance mapping for the references 312 performed by cognitive system 182 can assign a significance value to the industry TnC that indicates the positive nature of the deviation.

Once significance mapping for the references 312 has assigned significance values to the industry TnCs, the industry TnCs and their associated significance values can be used to generate TnC model 314, which will be used to evaluate the industry impact 354 of a TnC discovered in block of text 174N of legal document 170. In order to accomplish this, each industry TnC in a corresponding group TnC is combined with its assigned significance value to form an industry TnC tuple. This set of industry TnC tuples can be used (in isolation or in conjunction with sets of industry TnC tuples from other corresponding TnC groups) to generate TnC model 314. The resulting TnC model 314 is a set of known tuples of references from industry, which can be incorporated into cognitive system 182 and used by cognitive system 182 to establish the value of significance for a given reference.

TnC block currency computing module 230, as executed by computing environment 100, is configured to compute, using cognitive system 182, a block currency 334 for the TnC identified in block of text 174N of legal document 170. This block currency 334 indicates the significance of the impact of the TnC to contract party 181. Block currency 334 is created based on user preferences and, as such, is specific to a particular contract party 181. As such, block currency 334 of a particular TnC computed for a first contract party 181 may be different from block currency of the same TnC computed for a second contract party. Furthermore, block currency 334, which is specific to contract party 181 and evaluates the user impact 356, is computed independently from the standardized significance value that evaluates the industry impact 354. Thus, the significance for both the standardized significance value and the block currency 334 will differ for the TnC.

Though this disclosure pertains to the collection of personal data (e.g., workplace data), it is noted that in embodiments, users opt-in to the system (e.g., TnC assessing engine 200). In doing so, they are informed of what data is collected and how it will be used, that any collected personal data may be encrypted while being used, that users can opt-out at any time, and that if they opt-out, any personal data of the user is deleted.

In order to compute block currency, cognitive system 182 can search a plurality of the user's previous signed documents (e.g., prior legal agreements) 186A-N. As a result of this search, cognitive system 182 can discover TnCs within the prior legal agreements 186A-N (e.g., using identification techniques described previously). These discovered TnCs can be incorporated into cognitive system 182 and used by cognitive system 182 to identify the reference (TnC) impact for the user 332. For example, assume that contract party 181 has previously executed a number of prior legal agreements 186A-N for credit card applications and that each of these prior legal agreements 186A-N contained a TnC stating that the credit card has no annual fee. In such a case, cognitive system 182 could flag absence of an annual fee as being a preferred TnC for contract party 181 based on reference impact to the user 332 being high. Accordingly, a TnC in a block of text 174A-N of legal document 170 that includes an annual fee would be assigned an elevated block currency 334, indicating an evaluation of user impact that is relatively high. Alternatively, if TnCs in prior legal agreements 186A-N of contract party 181 contain annual fees or if the TnCs are mixed, with some having and some not having annual fees, the TnC in the block of text 174A-N of legal document 170 that included an annual fee could be assigned a lower or neutral block currency 334, indicating an evaluation of user impact that is relatively low. As such, the assignment of block currency 334 to particular TnCs personalizes the significance of terms and conditions for contract party 181 by deploying the block currency model operative.

TnC personal impact assessing module 240, as executed by computing environment 100, is configured to assess, using cognitive system 182 the personal impact of the TnC to the contract party. To make this assessment, cognitive system 182 evaluates 352 the occurrence 362 of TnC with respect to the impact 364 of contract party 181. Occurrence 362 represents the evaluated industry impact 354, as determined based on the standardized significance value assigned to the TnC by TnC model. Impact 364 is the evaluated user impact 354 of the TnC to contract party 181 represented by block currency 334. As such, the assessment is performed by cognitive system 182 based on an understanding of how block currency 334 is to be impacted, if at all, by the standardized significance value of the TnC assigned by TnC model 314. TnC personal impact assessing module 240 could assess a number of different personal impacts. For example, a TnC that has both a positive standardized significance value from TnC model 314 and a positive block currency 334 could be assessed a personal impact of definite positive “PP”. Similarly, a TnC that has both a negative standardized significance value from TnC model 314 and a negative block currency 334 could be assessed a personal impact of definite negative “NN”. In addition, a TnC for which the positive standardized significance exceeds a negative or neutral block currency 334 by a small amount or a positive block currency 334 exceeds a negative or neutral standardized significance by a small amount could be assessed a personal impact of positive from last occurrence “P”. Still further, a TnC for which the negative standardized significance exceeds a positive or neutral block currency 334 by a small amount or a negative block currency 334 exceeds a positive or neutral standardized significance by a small amount could be assessed a personal impact of negative from last occurrence “N”. Personal impact can also be assessed with a numerical value that quantifies an amount of consideration associated with a particular TnC in legal document 170.

TnC impact alerting module 250, as executed by computing environment 100, is configured to alert contract party 181 to the TnC. In an embodiment, legal document 170 can be rendered on a display of contract party 181 along with a graphical user interface. In an embodiment, graphical user interface can alert contract party 181 to TnCs having non-neutral impact contained in legal document 170, by navigating contract party 181 from one text block 174A to another text block 1748 that contain TnCs that have non-neutral personal impact, while bypassing any text block 174C that does not contain a TnC or that contain TnCs with neutral personal impact.

TnC impact alerting module 250 can also alert contract party 181 to the personal impact assessed to the TnC. For example, the graphical user interface can display each rendered TnC in conjunction with a graphical indicator that indicates the assessment of the TnC. This graphical indicator can include different text colors (e.g., different shades of green for positive and different shades or red for negative); different colors for highlighting of text; different background colors or shading; boxes of different types, colors, brightnesses, etc., surrounding the text block 174N; and/or the like. In an embodiment, one set of graphical indicators can be used to designate the standard significance value, a second set of graphical indicators can be used to designate block currency 334, and/or a third set of graphical indicators can be used to designate overall consideration for the TnC. Additionally, or in the alternative, values corresponding to assigned standard significance value, block currency 334, and/or overall consideration for the TnC can be displayed to contract party 181 instead of or in addition to the graphic indicator(s).

In an embodiment, these assessments of individual TnCs can be used to provide an overall recommendation to contract party 181 for legal document 170 as a whole. In order to accomplish this, an overall block of consideration can be formed for the legal document 170. Block of consideration refers to an arrangement of all specific consideration corresponding to each assessed TnC in legal document 170 in a direct acyclic graph so that it can be used to measure the overall impact of terms and condition included therein on contract party 181.

The personal impact of each graphed TnC can then be aggregated to measure the collective impact of the set of TnCs in legal document 170 on contract party 181. To accomplish this, assume the TnC model's significance is ‘W’ in some occurrence T. Block currency ‘g’ and TnC model ‘I’ are the block in the evaluation. Block currency and TnC model determine whether they highlight reference W, the reference of block currency is ‘c’, TnC model's valuation of reference is ‘v’, known to both modalities. ‘c’ is less than ‘v’, otherwise, consideration between block currency and TnC model does not realize.

This situation is modeled as ‘Reference evaluation model’ of subsequent references and block currency and TnC model are solved for. H: is set of considerations that are poised as a Directed Acyclic Graph (DAG); (This allows many active actions to be performed depending upon the difference in consideration between block currency 334 and TnC model 314.) T={t}, the various occurrences of the W and the significance consideration to be made at each occurrence is poised. The framework progresses as follows:
Occurrence case t=0, first occurrence, block currency first takes the consideration, evaluates an impact ‘x’, which x₀ ∈[c,v], which TnC model 314 then either tests for significance or rejects. When significance is high, then the evaluation ends, otherwise next occurrence is evaluated,
a. Occurrence case t=1, TnC model evaluates an impact x₁ ∈[c,v], block currency 334 has to consider for significance or reject. When block currency 334 establishes the significance then the evaluation ends, otherwise evaluation proceeds further;
b. Occurrences case t=2 . . . n the evaluation continues so forth: so long as no significance is established, in every positive occurrence, block currency 334 evaluates the impact that TnC model 314 has to test for significance or rejection, and in every negative occurrence, TnC model 314 evaluates the impact that block currency 334 must establish the significance or reject,
c. If no significance can be established, then it is evaluated as neutral or unchanged denoted a ‘D’.

This can be modeled this as an extensive evaluation with unmasked information.

At this stage, the most important considerations that are put forth in this legal document 170 have been identified, and these are being discussed as blocks against which model will have its own references. At this point, a set of modalities can be utilized so that the block currency 334 can accept or reject the significance of impact that has been classified by the model. This can be accomplished as follows:

(1) The set of the modalities is {g,l}
Let, X=[c, v] is the set of possible arrangements, ‘c’ is the significance of reference, ‘v’ is the TnC model's valuation.

The set of evaluation DAG ‘H’ is the set of all sequences of one of the following types, where t∈T, x⁵∈X for all s, ‘A’ means considers for significance and ‘R’ means reject.

H1: {φ} or {x⁰ R¹ [symbol] x¹, R,, . . . , x^{t}, R}

H2: {x⁰, R¹ [symbol] ¹, R,, . . . , x^{t}}

H3: {x⁰, R, x¹, R,, . . . , x^{t}, A}

H4: {x⁰, R, x¹, R . . . D}

### Where,

the block whose occurrence is to be evaluated for consideration will test the significance of X after the evaluation of H1, and test the significance of {A, R} after the evaluation of H2.
the evaluation of H3 and H4 are terminal;
H3 are finite and those of H4 are infinite.
[symbol] , is the left-skewed union, which means that the evaluation is pessimistic to reject policy

(2) The block function significance is defined as follows:

{P(h)=g|≡E h∈[H₁,H₂],h/∃φ,t∈[PP,P]}

{P(h)=l|≡E h∈[H₁,H₂],h/∃φ,t∈[NN,N]}

(3) The preference over the terminal evaluation are of H3 or H4, the set of terminal evaluation is partitioned as follows:

$$\\ {x}^{t} = \{ H 3 \text{::} x \vert {x}_{n} ϵ X ≡ ( x , t ) ∈ X = {⋃}_{{x}_{n}} {x}^{t} \}$$

Where,
for each x∈X and t∈T, the set of H3 for which x^{t}=x is the member of partition, denoted by (x,t);

$$\\ D = \{ H 4 \text{::} x \vert {x}_{n} ϵ X ≡ ( x , t ) ∈ X = {⋃}_{{\geq }_{i}} ( X \cdot T ) ⋃ D \}$$

Where,
for each x∈X and t∈T, the set of H4 is the member of the partition, denoted by D, so preference relation of each block T over evaluation DAG is induced from a preference relation i≥over the set (X×T)u∪{D}.

Utility functions u_{g} and uᵢ can now be formed for block currency 334 and the TnC model 314 respectively as,

u_{g}δ_{g}^{t}·W·(x−c)

uᵢ=δₗ^{t}·W·(ν−x)

Here,
δ_{g}^{t} is the ratio for marginal significance for ‘W’ quantity set forth by block currency 334,
δₗ^{t} is the ratio for marginal significance for ‘W’ quantity set forth by TnC model 314.

We can derive an equilibrium (x*, y*) as,

$$\\ \{ \begin{matrix}W \cdot ( y * - c ) = {δ}_{g}^{t} \cdot W \cdot ( x - c ) \\ W \cdot ( v - x \text{*)} = {δ}_{l}^{t} \cdot W \cdot ( v - x )\end{matrix}$$

Solving for x* and y*, we get,

$$\\ \{ \begin{matrix}{x}^{*} = \frac{( 1 - {δ}_{l} ) v + {δ}_{l} ( 1 - {δ}_{g} ) c}{1 - {δ}_{g} {δ}_{l}} \\ {y}^{*} = \frac{( 1 - {δ}_{g} ) c + {δ}_{g} ( 1 - {δ}_{l} ) v}{1 - {δ}_{g} {δ}_{l}}\end{matrix}$$

Here, we get the following result for block currency 334:
When t={P,PP}; block currency will have significance of

$$\\ {x}^{*} = \frac{( 1 - {δ}_{l} ) v + {δ}_{l} ( 1 - {δ}_{g} ) c}{1 - {δ}_{g} {δ}_{l}}$$

(1) When t={N.NN}; block currency will consider for significance any impact which is better than or equal to

$$\\ {y}^{*} = \frac{( 1 - {δ}_{g} ) c + {δ}_{g} ( 1 - {δ}_{l} ) v}{1 - {δ}_{g} {δ}_{l}}$$

and reject any impact less than

$$\\ {y}^{*} = \frac{( 1 - {δ}_{g} ) c + {δ}_{g} ( 1 - {δ}_{l} ) v}{1 - {δ}_{g} {δ}_{l}}$$

Here, we get the following result for TnC model:
(1) When t={P, PP}; block currency will consider for significance any impact which is better than or equal to

$$\\ {x}^{*} = \frac{( 1 - {δ}_{l} ) v + {δ}_{l} ( 1 - {δ}_{g} ) c}{1 - {δ}_{g} {δ}_{l}}$$

and any impact less than to

$$\\ {x}^{*} = \frac{( 1 - {δ}_{l} ) v + {δ}_{l} ( 1 - {δ}_{g} ) c}{1 - {δ}_{g} {δ}_{l}}$$

(2) When t={N,NN}; TnC model will always evaluate impact at

$$\\ {y}^{*} = \frac{( 1 - {δ}_{g} ) c + {δ}_{g} ( 1 - {δ}_{l} ) v}{1 - {δ}_{g} {δ}_{l}}$$

Based on these computations, a recommendation can be provided to contract party 181 as to whether legal document 170 is beneficial to contract party 181 based on the collective impact of all TnCs contained therein.

The model values (e.g., the standardized significance values) assigned to each TnC can be reincorporated into TnC model 314. In this manner, the model values in TnC model 314 can be re-baselined so that they refer to these new learnt values from block currency 334 computed for the particular TnC. In addition, any new TnCs, along with their corresponding legal documents 170, that have been either accepted or rejected can be incorporated into prior legal agreements 186A-N and can be used by cognitive system 182 to determine subsequent block currency 334 values.

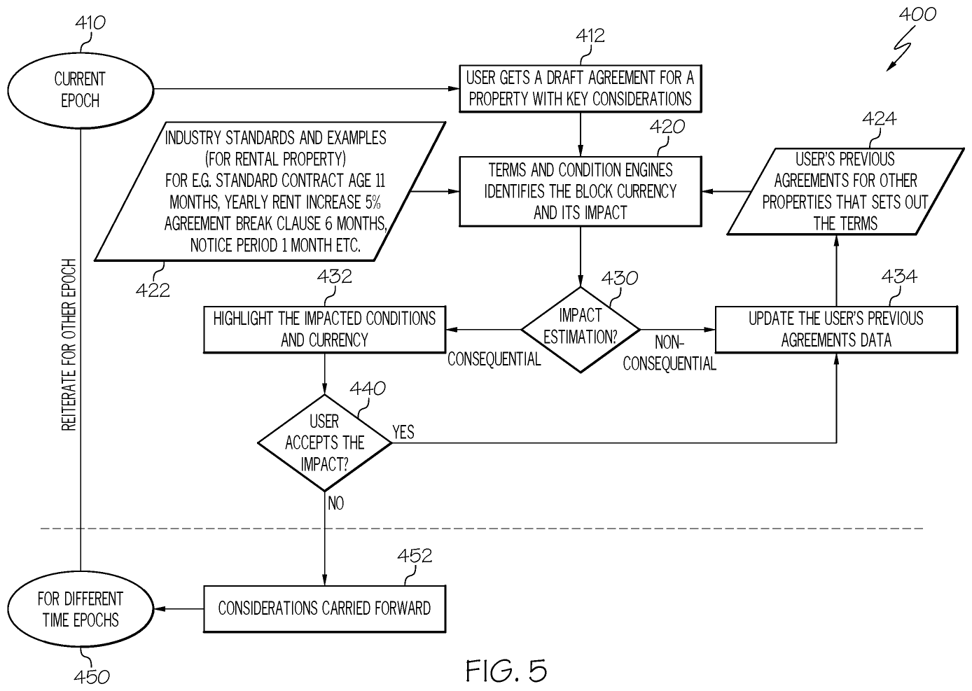

Referring now to FIG. 5, a logical flow diagram of an example case 400 is shown according to illustrative embodiments. Example case 400 is divided into two sections with the top section representing a current epoch 410 and the bottom section representing actions for different time epochs 450. Referring additionally to FIG. 2, example case 400 represents a case in which at 412 user (e.g., contract party 181) gets a draft agreement (e.g., legal document 170) for a property with key considerations (e.g., TnCs). At 420, terms and conditions engines (e.g., TnC assessing engine 200) identifies block currency 334 and its impact. To do so, at 422, industry examples (for rental property), which contain, e.g., standard contract age 11 months, yearly rent increase 5%, agreement break clause 6 months, notice period 1 month etc., are obtained (e.g., from TnC model 311). In addition, at 424, user's previous agreements (e.g., prior legal agreements 186A-N) for other properties that set out the terms thereof also obtained. At 430, a determination is made with respect to a TnC that estimates the impact of the TnC. If the impact is determined to be non-consequential, at 434 the user's previous agreements data is updated to reflect this. Otherwise, if the impact is determined to be consequential, at 432, the impacted conditions and the associated currency (consideration) is highlighted for the user. At 440 a determination is made as to whether the user accepts the impact. If so, at 434 the user's previous agreements data is updated to reflect this. Otherwise, at 452, the considerations are carried forward into different time epochs 450 to for potential inclusion in future draft agreements.

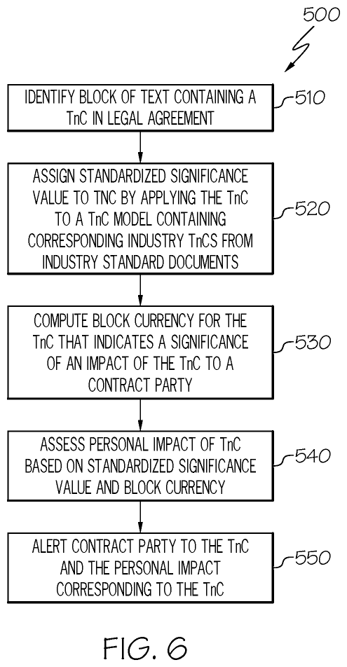

FIG. 6 depicts a method flow diagram 500 for assessing terms and conditions (TnC)s of a legal agreement according to an embodiment of the present invention. Referring additionally to FIGS. 2, 3 and 4, at 510, a block of text 174N that contains a TnC is identified in legal agreement 170 by cognitive system 182. At 520, a standardized significance value is assigned by cognitive system 182 to the TnC by applying the TnC to TnC model 314 containing corresponding industry TnCs from industry standard documents 184A-N. At 530, block currency 334 that indicates a significance of an impact of the TnC to contract party 181 is computed for the TnC by cognitive system 182. At 540, a personal impact of the TnC to contract party 181 is assessed by cognitive system 182 based on the standardized significance value and block currency 334. At 550, contract party 181 is alerted to the TnC and to the personal impact corresponding to the TnC.

It will be appreciated that the method process flow diagrams of FIGS. 5 and 6 represent possible implementations of process flows for assessing terms and conditions (TnC)s of a legal agreement, and that other process flows are possible within the scope of the invention. The method process flow diagrams discussed above illustrate the architecture, functionality, and operation of possible implementations of systems, methods, and computer program products according to various embodiments of the present invention. In this regard, each portion of each flowchart may represent a module, segment, or portion of code, which comprises one or more executable instructions for implementing the specified logical function(s). It will also be noted that each block of each flowchart illustration can be implemented by special purpose hardware-based systems that perform the specified functions or acts.

Further, it can be appreciated that the approaches disclosed herein can be used within a computer system for assessing terms and conditions (TnC)s of a legal agreement. In this case, as shown in FIG. 1, network module 115 can be provided, and one or more systems for performing the processes described in the invention can be obtained and deployed to computing environment 100 (FIG. 1). To this extent, the deployment can comprise one or more of: (1) installing program code on a computing device, such as a computer system, from a computer-readable storage medium; (2) adding one or more computing devices to the infrastructure; and (3) incorporating and/or modifying one or more existing systems of the infrastructure to enable the infrastructure to perform the process actions of the invention.

The exemplary computing environment 100 (FIG. 1) may be described in the general context of computer-executable instructions, such as program modules, being executed by a computer. Generally, program modules include routines, programs, people, components, logic, data structures, and so on, which perform particular tasks or implement particular abstract data types. Exemplary computing environment 100 may be practiced in distributed computing environments where tasks are performed by remote processing devices that are linked through a communication network. In a distributed computing environment, program modules may be located in both local and remote computer storage media including memory storage devices.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, System 200 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

It is apparent that there has been provided with this invention an approach for assessing terms and conditions (TnC)s of a legal agreement. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A computer-implemented method for assessing terms and conditions (TnC)s of a legal agreement, comprising the computer-implemented steps of:
identifying, using a cognitive system, a block of text in the legal agreement, the block containing a TnC of a set of the TnCs in the legal agreement;
assigning, by the cognitive system, a standardized significance value to the TnC by applying the TnC to a TnC model containing corresponding industry TnCs from industry standard documents;
computing, by the cognitive system, a block currency for the TnC that indicates a significance of an impact of the TnC to a contract party;
assessing, by the cognitive system, a personal impact of the TnC to the contract party based on the standardized significance value and the block currency; and
alerting the contract party to the TnC and the personal impact corresponding to the TnC.

2. The computer-implemented method of claim 1, the identifying further comprising detecting that the TnC is a new TnC that replaces a previous TnC in a previous version of the legal agreement.

3. The computer-implemented method of claim 1, further comprising:
searching a plurality of industry standard documents to discover industry TnCs within industry legal agreements;
collating each industry TnC of the industry TnCs into a corresponding TnC group that contains corresponding industry TnCs that correspond to the industry TnC;
determining, by the cognitive system, a TnC norm pertaining to the corresponding TnC group;
assigning, by the cognitive system, a significance value to each industry TnC in the corresponding TnC group based on a deviation of the industry TnC from the TnC norm; and
generating the TnC model from a set of industry TnC tuples that each include an industry TnC and the significance value assigned to the industry TnC.

4. The computer-implemented method of claim 1, further comprising:
searching, by the cognitive system, a plurality of prior legal agreements of the contract party to discover preferred TnCs within the prior legal agreements;
assigning, by the cognitive system, the block currency to the TnC based on a deviation of the TnC from a preferred TnC corresponding to the TnC.

5. The computer-implemented method of claim 1, wherein the personal impact is selected from a group, comprising: definite positive, positive from last occurrence, negative from last occurrence, definite negative, and not significant.

6. The computer-implemented method of claim 1, further comprising:
including the TnC in a direct acyclic graph together with other TnCs of the set of TnCs in the legal agreement;
determining the personal impact for each graphed TnC of the set of TnCs as a graph location of the graphed TnC within the direct acyclic graph is reached;
aggregating the personal impact of each graphed TnC to measure a collective impact of the set of TnCs on the contract party; and
providing a recommendation as to whether the legal agreement is beneficial to the contract party based on the collective impact.

7. The computer-implemented method of claim 3, further comprising:
incorporating the TnC into the TnC model; and
re-baselining the significance value for each industry TnC in the TnC model based on the TnC.

8. A system for assessing terms and conditions (TnC)s of a legal agreement, comprising:
a memory medium comprising program instructions;
a bus coupled to the memory medium; and
a processor, for executing the program instructions, coupled to the memory medium that when executing the program instructions causes the system to:
identify, using a cognitive system, a block of text in the legal agreement, the block containing a TnC of a set of the TnCs in the legal agreement;
assign, by the cognitive system, a standardized significance value to the TnC by applying the TnC to a TnC model containing corresponding industry TnCs from industry standard documents;
compute, by the cognitive system, a block currency for the TnC that indicates a significance of an impact of the TnC to a contract party;
assess, by the cognitive system, a personal impact of the TnC to the contract party based on the standardized significance value and the block currency; and
alert the contract party to the TnC and the personal impact corresponding to the TnC.

9. The system of claim 8, the program instructions that cause the system to identify further causing the system to detect that the TnC is a new TnC that replaces a previous TnC in a previous version of the legal agreement.

10. The system of claim 8, the program instructions further causing the system to:
search a plurality of industry standard documents to discover industry TnCs within industry legal agreements;
collate each industry TnC of the industry TnCs into a corresponding TnC group that contains corresponding industry TnCs that correspond to the industry TnC;
determine, by the cognitive system, a TnC norm pertaining to the corresponding TnC group;
assign, by the cognitive system, a significance value to each industry TnC in the corresponding TnC group based on a deviation of the industry TnC from the TnC norm; and
generate the TnC model from a set of industry TnC tuples that each include an industry TnC and the significance value assigned to the industry TnC.

11. The system of claim 8, the program instructions further causing the system to:
search, by the cognitive system, a plurality of prior legal agreements of the contract party to discover preferred TnCs within the prior legal agreements;
assign, by the cognitive system, the block currency to the TnC based on a deviation of the TnC from a preferred TnC corresponding to the TnC.

12. The system of claim 8, wherein the personal impact is selected from a group, comprising: definite positive, positive from last occurrence, negative from last occurrence, definite negative, and not significant.

13. The system of claim 12, the program instructions further causing the system to:
include the TnC in a direct acyclic graph together with other TnCs of the set of TnCs in the legal agreement;
determine the personal impact for each graphed TnC of the set of TnCs as a graph location of the graphed TnC within the direct acyclic graph is reached;
aggregate the personal impact of each graphed TnC to measure a collective impact of the set of TnCs on the contract party; and
provide a recommendation as to whether the legal agreement is beneficial to the contract party based on the collective impact.

14. The system of claim 10, the program instructions further causing the system to:
incorporate the TnC into the TnC model; and
re-baseline the significance value for each industry TnC in the TnC model based on the TnC.

15. A computer program product for assessing terms and conditions (TnC)s of a legal agreement, the computer program product comprising a computer readable storage device, and program instructions stored on the computer readable storage device, to:
identify, using a cognitive system, a block of text in the legal agreement, the block containing a TnC of a set of the TnCs in the legal agreement;
assign, by the cognitive system, a standardized significance value to the TnC by applying the TnC to a TnC model containing corresponding industry TnCs from industry standard documents;
compute, by the cognitive system, a block currency for the TnC that indicates a significance of an impact of the TnC to a contract party;
assess, by the cognitive system, a personal impact of the TnC to the contract party based on the standardized significance value and the block currency; and
alert the contract party to the TnC and the personal impact corresponding to the TnC.

16. The computer program product of claim 15, the program instructions stored on the computer readable storage device further to:
search a plurality of industry standard documents to discover industry TnCs within industry legal agreements;
collate each industry TnC of the industry TnCs into a corresponding TnC group that contains corresponding industry TnCs that correspond to the industry TnC;
determine, by the cognitive system, a TnC norm pertaining to the corresponding TnC group;
assign, by the cognitive system, a significance value to each industry TnC in the corresponding TnC group based on a deviation of the industry TnC from the TnC norm; and
generate the TnC model from a set of industry TnC tuples that each include an industry TnC and the significance value assigned to the industry TnC.

17. The computer program product of claim 16, the program instructions stored on the computer readable storage device further to:
search, by the cognitive system, a plurality of prior legal agreements of the contract party to discover preferred TnCs within the prior legal agreements;
assign, by the cognitive system, the block currency to the TnC based on a deviation of the TnC from a preferred TnC corresponding to the TnC.

18. The computer program product of claim 15, wherein the personal impact is selected from a group, comprising: definite positive, positive from last occurrence, negative from last occurrence, definite negative, and not significant.

19. The computer program product of claim 17, the program instructions stored on the computer readable storage device further to:
include the TnC in a direct acyclic graph together with other TnCs of the set of TnCs in the legal agreement;
determine the personal impact for each graphed TnC of the set of TnCs as a graph location of the graphed TnC within the direct acyclic graph is reached;
aggregate the personal impact of each graphed TnC to measure a collective impact of the set of TnCs on the contract party; and
provide a recommendation as to whether the legal agreement is beneficial to the contract party based on the collective impact.

20. The computer program product of claim 19, the program instructions stored on the computer readable storage device further to:
incorporating the TnC into the TnC model; and
re-baselining the significance value for each industry TnC in the TnC model based on the TnC.
